(19) United States
(12) Patent Application Publication
(10) Pub. No.: US 2010/0037905 A1
(43) Pub. Date: Feb. 18, 2010

(54) FILTER OR FILTER ELEMENT FOR TOBACCO SMOKE CIGARETTE CONTAINING SUCH A FILTER OR FILTER ELEMENT AND METHOD FOR PRODUCING SUCH A FILTER OR FILTER ELEMENT

(76) Inventors: Günter Maurer, Neuenburg (DE); Eberhard Teufel, Gundelfingen (DE); Paul Rustemeyer, Gundelfingen (DE); Eckart Schütz, Gundelfingen (DE)

Correspondence Address: FAY SHARPE LLP, 1228 Euclid Avenue, 5th Floor, The Halle Building, Cleveland, OH, 44115, US

(21) Appl. No.: 11/991,494

(22) PCT Filed: Aug. 10, 2006
(86) PCT No.: PCT/EP2006/007922

§ 371 Date: Oct. 9, 2009

(30) Foreign Application Priority Data
Sep. 5, 2005 (DE) 10 2005 042099.0
Dec. 20, 2005 (DE) 10 2005 060972.4

(51) Int. Cl. A24D 3/04; B01D 53/04; A24B 1/00; B05D 1/36

(52) U.S. Cl. 131/344; 96/121; 131/360; 427/258

(57) ABSTRACT

The invention relates to a filter or filter element with a substantially cylindrical filter body, which contains, in particular, at least two different additives, the additives being located in at least two zones which are arranged one after the other in the longitudinal-axial direction of the filter body and/or in at least two zones, more particularly layers, which at least in sections lie one above the other in the radial direction of the filter body. The invention also relates to a filter or filter element for tobacco smoke, comprising a substantially cylindrical filter body that can be made from a material which in its initial state is flat, more particularly endlessly curled filaments, paper, fibrous webbing, textile material, non-woven and the like, the filter body comprising at least two zones which are arranged one after the other in the longitudinal-axial direction of the filter body, a tobacco-end zone containing an additive and a mouth-end zone being free from additive. The subject matter according to the invention permits better filtering of burnt products. The invention also relates to a method which is particularly suitable for producing filters or filter elements for tobacco smoke, in which method a filter body is provided with at least two different zones, the additive being applied to a flat starting material from which the filter body is formed in substantially parallel strips and/or in layers one above the other.

This invention relates to a filter or filter element for tobacco smoke having an essentially cylindrical filter body.

Tobacco smoke filters are used in filter cigarettes to remove the tobacco combustion products from the smoke at least partly before the smoke is inhaled. To improve the filtration efficiency of the tobacco smoke filter, it is known to add an additive, especially activated carbon in particulate form, to the filter. This can be done in various ways depending on the particular type of filter used.

It is known for example to provide in the filter a chamber which is packed with activated carbon and through which the combustion, products flow during smoking and are at least partly adsorbed by the granular activated carbon present in the chamber. The disadvantage with these chamber filters is that when the chamber is not completely packed, which is generally the case owing to the limiting of the fill level of the chamber, a bypass effect develops and channels at least a portion of the combustion products past the activated carbon without their being retained.

This disadvantage is avoided by one-piece filters or filter elements where the activated carbon is uniformly distributed in the filter material to achieve retention of the combustion products throughout the entire cross section of the filter.

These one-piece filters can be classified into space filters on the one hand and surface filters on the other. Space filters are produced from filter tow formed from stuffer box crimped continuous filaments. A solution of about 30% of cellulose-2,5-acetate in acetone is pressed through spinneret dies, the acetone is evaporated in a spin shaft, a multiplicity of filaments are banded and the band is subsequently stuffer box crimped. The product is then dried and pressed to form bales. The filter tow is removed from the bale and processed on a filter rod machine into filter rods. In the process, the filter tow is stretched in a stretching appliance, provided with an agent to adhere the filaments together to form a slubbing, which is cross-axially compacted, wrapped with paper and cut to the final length of the filter rods.

Such space filters may contain the finely divided, granular activated carbon lodged in the filamentous network or sitting on the individual filaments. This can be effected for example by sprinkling with activated carbon granules or by applying the activated carbon from a slurry in an aqueous phase, a volatile organic vehicle or a plasticizer liquid. In this process, the particulate activated carbon becomes more or less uniformly distributed in the entire filter volume.

Surface filters are produced by proceeding from a sheet material, for example paper, spun-bondeds, textile wovens or nonwovens, as starting material. For filter production, the sheet-like starting material is unrolled off a bobbin, shaped into a rod-shaped product and cross-axially compacted, wrapped with paper and cut to the final length of the filter rods. The sheet material before shaping into a rod can be crimped parallel to its direction of transport by means of a creping appliance to lower the material's density and to influence the draw resistance of the filter.

The activated carbon is introduced into surface filters by doping the sheet-like starting material, especially paper, with activated carbon. Paper filters thus doped contain small activated carbon particles which become bound to the paper in the papermaking operation. The nature of the process here is again such that the activated carbon becomes distributed throughout the entire filter volume.

Reference is made to WO 01/28369 A1 for details concerning space and surface filter construction and production.

DE 10 2004 048 651, which was unpublished at the earliest priority date of the present invention, discloses using fibres, filaments or self-supporting films/sheets which contain on the inside further additives which improve the properties of the fibres, filaments or self-supporting films/sheets. These further additives comprise plasticizers, marking agents, pigments and/or stabilisers. These additives have no retentive effect on smoke ingredients. Moreover, all the additives, i.e., not only the activated carbon but also the further additives provided in the interior of the fibres, filaments and self-supporting films/sheets, are uniformly distributed throughout the entire filter volume.

U.S. Pat. No. 3,311,519 discloses a space filter produced from classic filter tow. Activated carbon has been added to the space filter by being applied to the stretched filter tow material in stripes.

The filters described above have the disadvantage that the amount of activated carbon that can be introduced into the filter body is curtailed by the filter volume and also by the draw resistance still accepted by the smoker, the draw resistance increasing disproportionately when the amount of activated carbon is excessive. As a result, the tobacco filter's retentive effect, chiefly due to the activated carbon, is curtailed.

It is an aim of the present invention to provide a filter or filter element and also a cigarette equipped with such a filter or filter element that permit improved filtration of combustion products. A process for producing such a filter or filter element shall also be provided.

We have found that this aim is addressed for the filter or filter element aspect by the features of claims 1 and 13, alternatively, and for the cigarette aspect by the features of claim 14. With regard to the process, the aim is achieved by the features of claim 15.

This invention rests essentially on the concept of providing a tobacco smoke filter or filter element having an essentially cylindrical filter body comprising especially at least two different additives. The additives are arranged in at least two zones disposed in succession in the longitudinally axial direction of the filter body and/or in at least two zones superposed at least regionally in the radial direction of the filter body, in particular layers.

The present invention also provides a tobacco smoke filter or filter element having an essentially cylindrical filter body obtainable from a material which is sheet-like in the original state, especially endlessly crimped filaments, paper, fleece, textile tissue, nonwovens and the like, characterised in that the filter body comprises at least two zones disposed in succession in the longitudinally axial direction of the filter body, one tobacco-side zone comprising an additive and one mouth-side zone being free of additive.

The resulting spatial separation of the various additives, although a certain degree of mixing of the additives in the border regions of the zones cannot be ruled out, creates the precondition that different additives can be combined with each other which enhance the overall filtration efficiency of the filter. This can be done for example through a suitable choice of additives which cooperate to amplify the efficacy of the individual additives. This invention also makes it possible for the spectrum of different combustion products which can be removed from the smoke through a selective retention on the part of the various additives to be expanded.

This invention further creates the precondition for the use of different additives whereby one additive performs a protective function for the other additive or additives. In this protective function, an upstream additive filters the ingredients which are harmful to the efficacy of the downstream additive out of the smoke before they come into contact with the downstream additive. For this, the present invention provides that the various additives are spatially separated, namely in at least two zones disposed in succession in the longitudinally axial direction of the filter body and/or in at least two zones superposed at least regionally in the radial direction of the filter body.

The zonewise arrangement of the various additives provides the further advantage that different additives can be used which, if homogeneously mixed with each or one another, would partake in an unwanted chemical reaction. The above-described spatial separation of the additives makes it possible for such additives to freely develop their effects without adversely affecting one another.

In a preferred embodiment, the filter comprises a filter body composed of a sheet-like filter material, especially composed of endlessly crimped filaments, paper, fleece, textile tissue, nonwovens or the like. The present invention is especially useful in connection with the use of surface filters, the retentive performance of which is significantly enhanced, so that the well-known advantages of surface filters, especially the comparatively low draw resistance and also the good biodegradability, take especial effect.

The additives can be present on and/or in the sheet-like filter material, so that, depending on the type of filter material, there is provision for penetration of the additives into the interior of the filter material and/or for the application of the additives to the surface of the filter material.

To ensure that the filter's end face visible to the smoker offers a light-coloured, especially a white appearance, it can be provided that a zone disposed immediately mouth-side is essentially free of additives.

The present invention comprises all additives capable of influencing smoke properties, although additives having a retentive effect are preferred, so that at least one additive comprises an agent having a retentive effect, especially a selective retentive effect, on smoke ingredients. An additive may comprise one component or a mixture of a plurality of components.

An enhanced filtration efficiency, more generally an enhanced efficacy of the additives on the smoke or the smoke properties, is obtainable when at least one additive comprises an agent for enhancing the efficacy of at least one further additive.

Advantageously, at least one additive comprises a sorbent, especially an adsorbent or an absorbent, an effective way of achieving retention of smoke ingredients.

The sorbent may comprise activated carbon, a polymer resin, especially phenolic resin or metal oxides, metal hydroxides and/or metal oxide hydrates, especially those of aluminium, silicon, titanium and/or magnesium.

In a preferred embodiment of the present invention, at least one additive comprises a catalyst, especially for oxidising carbon monoxide, the catalyst being disposed either downstream of the sorbent or underneath the sorbent. This disposition of the catalyst ensures that smoke ingredients which would poison the catalyst are filtered out of the smoke by the sorbent upstream of the catalyst. This effect is also to be expected when the additives are in superposed disposition.

The catalyst may comprise noble metal catalysts, especially composed of platinum, gold or mixed alloys of gold and silver.

The entire filtration efficiency of the filter can be further improved when at least one additive comprises an electrophilic reagent having a selective retentive effect on amines, especially on primary or secondary amines. The electrophilic reagent having a selective retentive effect combines with the at least one other additive provided according to the present invention in ensuring that a comparatively large spectrum of different smoke ingredients can be filtered out of the smoke.

Alternatively or additionally to the electrophilic reagent, at least one additive may comprise a nucleophilic reagent having a selective retentive effect on aldehydes and ketones, especially acetaldehyde, protonaldehyde, butyraldehyde or acetone-propionaldehyde. It is especially the combination of the nucleophilic reagent with the electrophilic reagent and the attendant combination of the various selective retentive effects which ensures that especially many different smoke ingredients are filtered out of the smoke. The combination of the electrophilic reagent with the nucleophilic reagent is achieved by the present invention's arrangement of the two additives in different spatially separated zones provided in the longitudinally axial and/or radial directions of the cylindrical filter body, preventing a chemical reaction between the additives.

Independent claim 13 provides that the tobacco smoke filter or filter element has an essentially cylindrical filter body obtainable from a material which is sheet-like in the original state, especially endlessly crimped filaments, paper, fleece, textile tissue, nonwovens and the like. The filter body further comprises at least two zones disposed in succession in the longitudinally axial direction of the filter body, one tobacco-side zone comprising an additive and one mouth-side zone being free of additive.

In contrast to U.S. Pat. No. 3,311,519, the filter according to independent claim 13 is a surface filter obtained from a sheet-like starting material. The use of the sheet-like starting material distinguishes a surface filter from a space filter with regard to the different filter structures. Especially, surface filters have a characteristic passageway structure which results from the pleating of the sheet-like starting material and which space filters do not have.

The present invention's filter or filter element according to independent claim 13 has the advantage that manufacturing costs can be reduced compared with customarily used dual filters, since the surface filter of the present invention is a mono filter. The visible end face of the filter, moreover, appears white, as overwhelmingly demanded by the consumer. The untreated zone, i.e., the zone produced free of additives, further ensures that, when the additive-free zone is arranged on the mouth side of the filter, the additive provided on the tobacco side is substantially not detached from the filter and breathed in.

The process of the present invention has the essential feature of the additives being applied to a sheet-like starting material for the filter body in essentially parallel stripes and/or in superposed layers. The stripewise application of the additives and/or the layerwise application of the additives to the sheet-like filter starting material establishes the precondition for the zone- or layerwise arrangement of the additives after the sheet-like starting material is cross-axially shaped into a filter rod and compacted.

In a preferred embodiment of the process according to the present invention, one of the additives is applied in a first stripe and a further of the additives is applied in second and third stripes which are disposed on both longitudinal sides of the first stripe and are each narrower than the first stripe. This arrangement of the various additives provides for an especially efficient manufacture of the filter, since the filter can be cut to its final length in the region of the broader first stripe, one cut creating two filter end products, since the broader first stripe has on either side the narrower second and third stripes formed from the other additive. The second stripe with the part-stripe resulting from the first stripe is assigned to one filter. The second stripe with the other part-stripe resulting from the first stripe is assigned to a further filter. As a result, the present invention's arrangement of the zones which are successive in the longitudinally axial direction can be achieved through a comparatively small number of operations, especially with regard to cutting the filter rods to length.

The additives can be applied by spraying and/or printing, especially by inkjet processes, rotary printing processes or screen printing processes. Such processes, which are known per se in connection with the production of print media, permit rapid and precise application of the various additives in spatially separated functions.

The additives can be applied in solution or in dispersion, in which case the solvent medium and the dispersion medium, respectively, is subsequently evaporated. This permits an especially simple sprayed or printed application of the additives to the sheet-like starting material.

The invention will now be more particularly elucidated with further details using operative examples and referring to the accompanying drawings.

In the drawings:

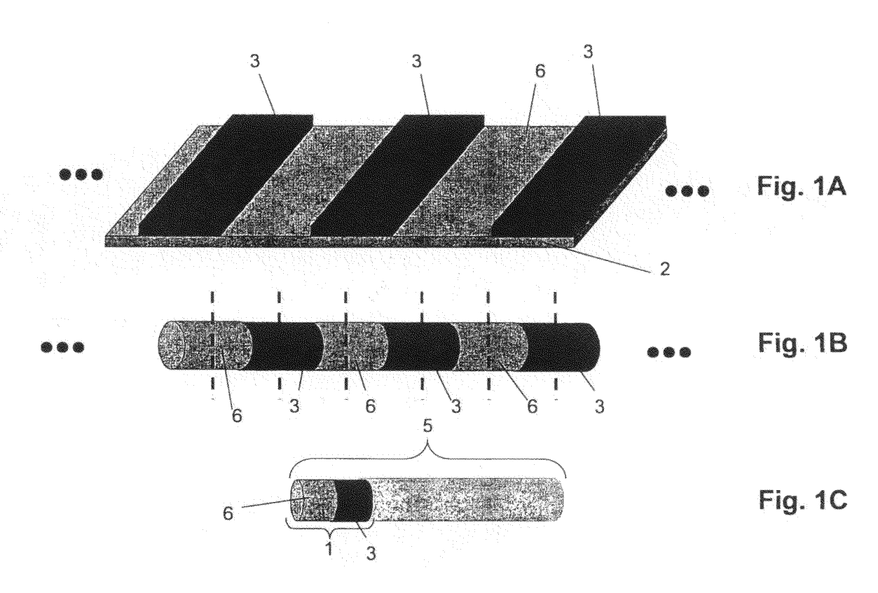

FIG. 1a shows a sheet-like filter material as a starting material for the production of a surface filter alternatingly printed with one additive;

FIG. 1b shows a filter rod produced from the printed sheet-like filter material of FIG. 1a;

FIG. 1c shows a cigarette incorporating a filter produced from the filter rod of FIG. 1b;

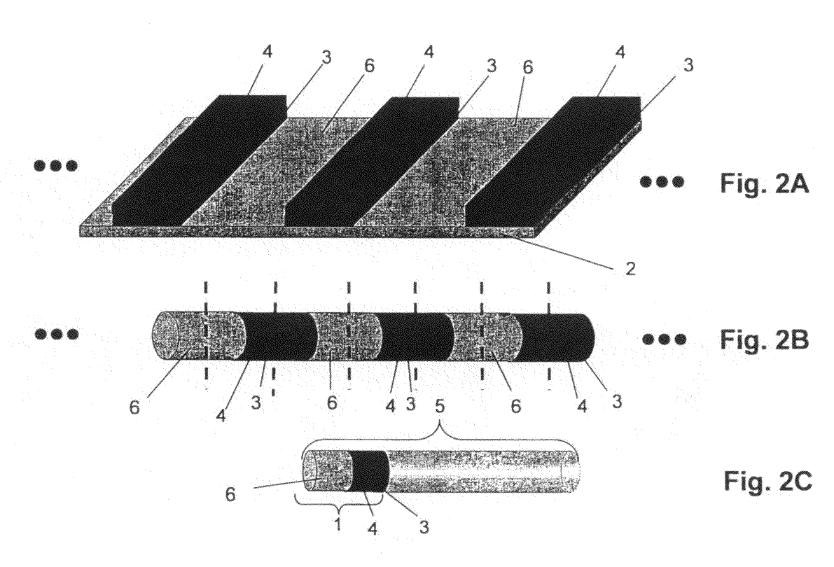

FIG. 2a shows a sheet-like filter material as a starting material for the production of a filter rod alternatingly printed with two different additives;

FIG. 2b shows a filter rod produced from the printed sheet-like filter material of FIG. 2a and indicates the locations where the filter rod is cut to length;

FIG. 2c shows a cigarette incorporating a filter produced from the filter rod of FIG. 2b;

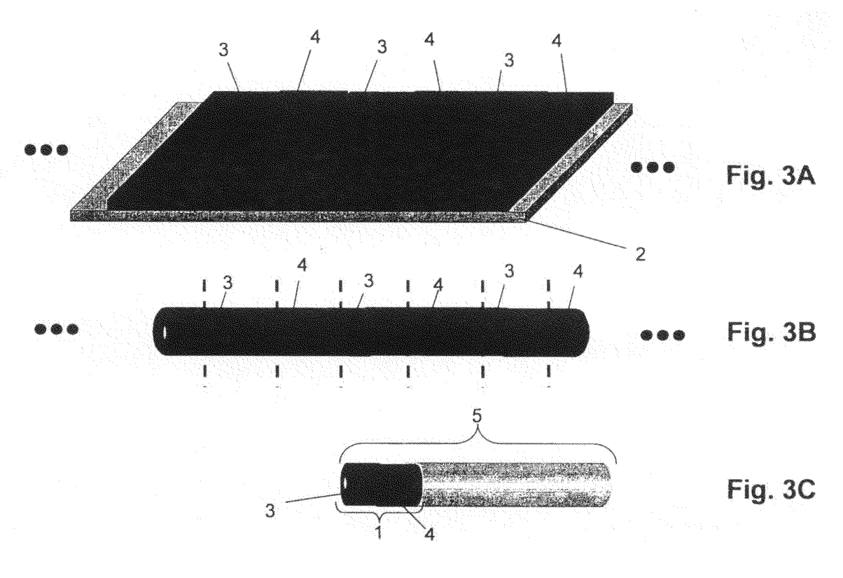

FIG. 3a shows a sheet-like filter material as a starting material for a filter rod printed alternatingly with two different additives which are present in stripes which are in a parallel arrangement;

FIG. 3b shows a filter rod produced from the printed sheet-like filter material of FIG. 3a;

FIG. 3c shows a cigarette incorporating a filter produced from the filter rod of FIG. 3b;

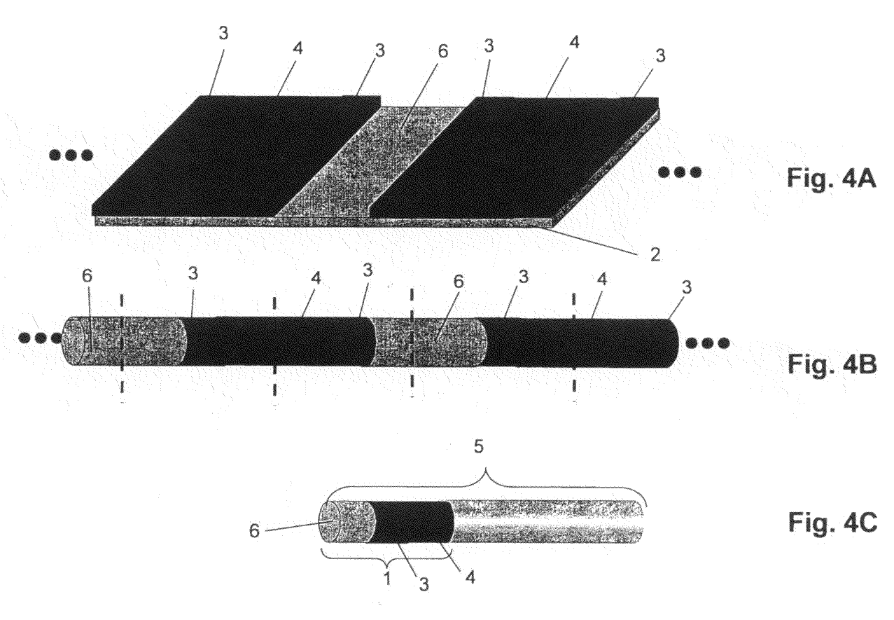

FIG. 4a shows a sheet-like filter material as a starting material for a filter rod printed alternatingly with two different additives present in stripes differing in width;

FIG. 4b shows a filter rod produced from the printed sheet-like filter material of FIG. 4a;

FIG. 4c shows a cigarette incorporating a filter produced from the filter rod of FIG. 4b; and

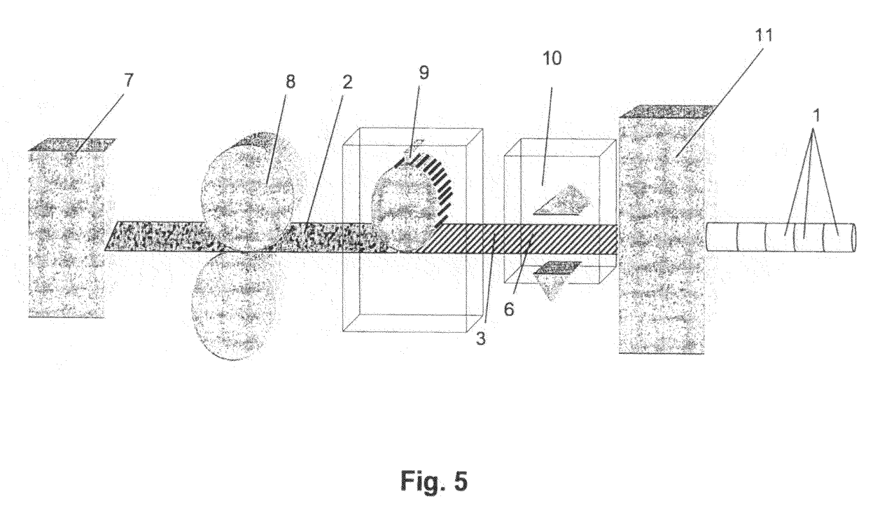

FIG. 5 shows the diagrammatic construction of an installation for producing filter rods.

FIGS. 1a, 1b and 1c depict the starting material present at various stages of cigarette production, i.e., the sheet-like filter material, the intermediate product, i.e., the filter rod, and the end product, i.e., the cigarette. The operative example illustrated with reference to FIGS. 1a, 1b, 1c relates to the filter or filter element according to independent claim 13 wherein a surface filter has at least two zones disposed in succession in the longitudinally axial direction of the filter body, a tobacco-side zone containing an additive and a mouth-side zone being free of additive.

Production of such a filter or filter element utilizes a sheet-like filter material as starting material, as shown in FIG. 1a. This sheet-like filter material can be made for example from endlessly crimped filaments, paper, fleece, textile tissue, nonwovens or similar sheet materials. The sheet-like filter material 2 is continued in the longitudinal direction in the form of an endless web of material, as depicted in FIG. 1a. The additive 3 is printed onto the sheet-like filter material 2 in stripes 3 which are each arranged essentially parallel to each other. Between the stripes 3 there are in each instance unprinted stripes 6, the width of which essentially corresponds to the width of stripes 3. The result is thus an alternating arrangement of printed and unprinted regions and thus an alternating arrangement of additised and additive-free stripes 3, 6.

It is to be noted in this connection that the dimensions depicted in FIG. 1a, especially the thickness/width dimensions of the layers applied to the sheet-like filter material 2, are to be understood as schematic. In reality, the thickness of [symbol] the stripes 3 is thinner than depicted in FIG. 1a. As can further be seen in FIG. 1a, the additive in the region of zone 3 is present on top of the sheet-like filter material, i.e., on the surface thereof. However, the additive can also penetrate into the filter material 2 and/or saturate through the filter material 2 zonewise or stripewise. Nor do the two zones have to be of equal width, as depicted in the drawing. Neither the absolute width nor the width ratios of the zones are subject to critical restrictions. Nor does the printed zone have to extend in the cross-axial direction over the entire width of the sheet-like filter material.

This holds for all other operative examples of this application as well.

An example of a useful additive is a sorbent comprising activated carbon, silicon dioxide or a polymer resin. It is also possible to use a CO oxidation catalyst as additive.

The printed sheet-like filter material of FIG. 1a is processed in a filter rod machine by pleating or rolling in a conventional manner to form the filter rod 1a shown in FIG. 1b. Only part of the filter rod 1a is depicted in FIG. 1b. The additive stripes 3 printed onto the sheet-like filter material 2 form alternatingly arranged zones after the filter material 2 has been processed into the filter rod 1a depicted in FIG. 1b. As can be seen in FIG. 1b, the various zones 3, 6 are successive in the longitudinally axial direction of the filter rod 1a, and additive-free zone 6 and additive-containing zones 3 alternate. The thus obtained filter rod 1a of FIG. 1b is cut at the locations indicated in FIG. 1b to produce filter or filter elements. The resulting filter 1 is depicted in FIG. 1c and has an additive-free zone 6 as well as an additive-containing zone 3. Filter 1, as depicted in FIG. 1c, is used together with a cigarette 5, the additive-containing zone 3 being disposed on the tobacco side of the cigarette and the additive-free zone 6 on the mouth side.

In use, the additive-containing zone 3, i.e., for example the activated carbon present in zone 3, retains the smoke constituents. The additive-free zone 6 disposed on the mouth side stops the additive present in the zone 3 from leaving filter 1 and being breathed in by the smoker. In addition, the additive-free zone 6 ensures a white end face for filter 1, as desired by the consumer.

The operative example depicted in FIGS. 2a, 2b, 2c relates to the filter or filter element according to claim 1. Again the various process stages with regard to the starting material, the intermediate product and the end product are illustrated.

FIG. 2a shows that the sheet-like filter material 2 has been printed with different additives, especially with two different additives. These additives are disposed on the sheet-like filter material 2 such that they are essentially spatially separated. The depicted dimensions, especially the thickness dimensions, are to be understood as schematic in this operative example as well.

The spatial separation of the additives in the operative example shown in FIG. 2a is established by applying the additives layerwise, i.e., in superposed zones 3, 4.

The zones 3, 4, like the operative example of FIG. 1a, are applied, especially by printing, stripewise transversely to the longitudinal extension of the filter material 2. The individual parallel stripes are spaced apart, and the resulting clear spaces are not printed. The result is a sheet-like filter material 2 having additive-containing zones 3, 4 and additive-free zones 6 in an alternating arrangement in the longitudinal direction of the filter material and extending essentially transverse to the longitudinal direction. The additive provided directly on the surface of the filter material 2 can also penetrate into the filter material 2 or saturate through the filter material 2 such that the outside layer or zone 4 is in direct contact with the surface of the filter material 2. The spatial separation of the two zones 3, 4 results from the zone 3 being disposed in the filter material 2 and the zone 4 being disposed on the surface of the filter material 2.

The filter material 2 thus prepared is processed to form the filter rod depicted in 2b, which, cut off to the appropriate length, forms the filter 1, as depicted. in FIG. 2c.

The filter 1 thus produced accordingly comprises two spatially separated additives in zones 3, 4 or layers, superposed in the radial direction of the filter body. The radially inside zone 3 is overlaid by the radially outside zone 4. The additive-containing zones 3, 4 are, as depicted in FIG. 2c, disposed in the cigarette on the tobacco side while the additive-free zone 6 is disposed in the cigarette on the mouth side.

The operative example depicted in FIG. 3a comprises a sheet-like filter material which serves as starting material for the filter 1 shown in FIG. 3c. The sheet-like filter material 2 of FIG. 3a has been provided with a plurality of different additives, especially with two different additives, which are applied, especially by printing, stripewise to the filter material 2 transversely to its longitudinal extension. The resulting stripewise zones are in a parallel arrangement and directly adjoin each other. In contrast to the operative example of FIGS. 2a, 2b, 2c the present operative example provides that the spatial separation of the additives is established by arranging the zones 3, 4 side by side and not on top of each other.

The filter material 2 thus printed is then processed into a filter rod 1a, as depicted in FIG. 3b. The filter rod 1a is cut into individual filters 1, as indicated in FIG. 3b. It is to be noted in this connection that the width of the stripes or zones 3, 4 on the sheet-like starting material 2 is twice the width of the zones 3, 4 of filter 1, which is obtained by appropriate cutting from the filter rod 1, as depicted in FIG. 3b.

The filter 1 depicted in FIG. 3c thus has an essentially cylindrical filter body comprising a plurality of additives, especially two different additives. These additives are present in two zones 3, 4 which are successive in the longitudinal direction of the filter body. The additives thus disposed are therefore essentially spatially separated.

It can be seen in FIGS. 3b, 3c that the originally sheet-like filter material 2 is on the inside of filter rod 1a or filter 1 and is peripherally surrounded by the zones 3, 4 which are disposed in a successive arrangement in the longitudinal extension of filter 1 or filter rod 1a.

A further operative example of a filter concerning claim 1 is presented in FIGS. 4a, 4b and 4c. This filter combines the spatial separation of two different additives with an additive-free zone.

To this end, the filter material 2 depicted in FIG. 4a has applied to it, especially by printing, different additive zones 3, 4 in a stripewise side by side arrangement. The zones 3, 4 are applied as in operative Examples 1a, 2a, 3a essentially transversely to the longitudinal extension of the sheet material 2. The additives are applied so as to produce alternating zones 3, 4 which are each separated by a zone 6, which is additive free. The alternating zones 3, 4, have on each of the longitudinal sides of a zone 4 of one of the two additives, parallel to zone 4, a narrower zone 3 of the other additive. Zone 4 with the one additive is twice as wide as each zone 3 of the other additive.

The sections with the alternating zones 3, 4 in turn alternate with the additive-free zones 6, as depicted in FIG. 4a.

The sheet material 2 thus processed is then further processed to form a filter rod, as depicted in FIG. 4b. The filter rod 1a of FIG. 4b is used to produce the filter 1 by cutting in each of the additive-free zones 6 and also of the broad additive-containing zones 4, the additive-free zones 6 likewise being twice as wide as the additive-containing zones 3 of the other additive. This creates, in an especially efficient manner, a filter 1 which comprises three different, spatially separated zones and which is shown in FIG. 4c. This filter 1 comprises a mouth-side additive-free zone 6 which is preceded in the upstream direction of the smoke by an additive-containing zone 3 of one additive and that in turn is preceded again in the upstream direction of the smoke by a further zone 4 of a different additive.

The filters shown in FIGS. 2c, 3c, 4c, and the arrangement of the zones of these filters, can be combined with each or one another. It is possible, for example, to dispose the three different additives such that two additives are disposed in stripe-shaped layers on top of each other on the starting material, the third additive being disposed in a further stripe parallel to the stripe comprising two layers. A filter produced from a starting material thus prepared comprises a zone having a radially inside subzone and a radially outside subzone. This zone of two spatially separated additives is preceded or followed in the longitudinally axial direction of the filter by a further zone comprising the third additive. This filter can also be combined with a non-additised mouth-side zone.

It is also possible to configure the disclosed filters as filter elements which are used together with further other filter elements in a dual or multi filter design.

It may also be expressly noted that the depiction in FIGS. 4a, 4b and 4c is just one of many embodiments of the present invention and that it is not necessary for the individual filter zones to be of equal width.

There now follow observations on the advantages, or mode of action, of a filter having two spatially separated retention materials or generally having two spatially separated different additives.

The different additives can be chosen such that one additive performs a protective function for a second additive. For example, the tobacco-side zone can be provided with activated carbon and the downstream zone can be configured as a CO oxidation catalyst. A further downstream zone can be configured on the mouth side as an additive-free zone. In this case, the activated carbon retains smoke constituents which without this upstream, prefilter zone would poison the CO oxidation catalyst. Catalyst performance is therefore better. The same logic applies when the additives are arranged in radially superposed layers and not disposed successively in the longitudinally axial direction of filter 1.

The filters or filter elements depicted in FIGS. 2c, 3c and 4c also make it possible to combine two additives which, if in a homogeneous mixture, would undergo an unwanted chemical reaction, as is likely in the case of nucleophilic and electrophilic additives for example. The spatial separation of the retention materials which is made possible according to the present invention preserves the selective retentive effect of each of the nucleophilic and electrophilic additives, so that the nucleophilic additives selectively retain aldehydes, for example, and the electrophilic additives selectively retain amines for example. The mouth-side additive-free zone, which is optional, not only provides the appealing exterior, i.e., the white end face, but also stops additives being detached from the filter and breathed in by the smoker.

The process for producing the filters depicted in FIGS. 1, 2, 3 and 4 will now be especially illustrated with reference to examples and the production installation schematically depicted in FIG. 5.

### EXAMPLE 1

A filter tow of specification 2,1Y48 (filament linear density 2.33 dtex; total linear density 53 333 dtex) was spread out on a customary KDF 2 two-stage stretching system 7 from Hauni, Hamburg, and sprayed with 8% of triacetin. After leaving the deflecting roll, filter tow web 2 having a minimum width of 150 mm is threaded into a pair of heated calender rolls 8 and calendered at an effective line pressure of 40 kg/cm. The profiled calender rolls 8 have a diameter of 230 cm and a grooved width of 350 mm and have 10 profile grooves per cm while the other is unprofiled. They are heated to 150° C. with a silicone oil. The groove profile is trapezoidal with an upper width of 0.4 mm and a depth of 0.5 mm.

After leaving the calender rolls 8 the fleece 2 thus produced is led through a spray system 9 in which an activated carbon suspension is applied by rotors as fine droplets through a closable slit diaphragm onto the continuous web of material. The diaphragm is rapidly opened and closed as the web of material travels continuously through the spray system, so that zones 3, 4, where suspension is loaded, and additive-free zones 6 are created on the web of material and alternate in the longitudinal direction. The choice of the closing frequency of the slit diaphragm and of the speed of the web of material makes it possible to choose the width of the additive-containing zones 3, 4 and also of the additive-free zones 6. Here, the web of material travels through the spray system at 10 m/min and the slot diaphragm opens and closes at a frequency of about 4 sec⁻¹, the open periods of the diaphragm and the closed periods of the diaphragm being of the same length. The width of the stripes admixed with activated carbon and also the width of the additive-free stripes 6 are therefore in each case 21 mm.

After leaving the spray system 9, the web of material is led through a circulating air dryer 10 at 150° C. The dryer 10 has a drying section of 4 m and thus ensures the evaporative drying of the suspension and the fixing of the activated carbon on the fleece 2.

After leaving the dryer 10, the fleece 2, mixed with activated carbon, is transferred to a commercially available KDF 2 filter rod machine 11 from Körber, Hamburg, where it is rope pleated in an inlet die, wrapped with paper and cut to a filter rod length of 126 mm. Care is taken to ensure that the cutting of the filter rods is in each case done centrally in an activated carbon zone 3 or in the middle of a non-additised zone 6. The applied amount of activated carbon in the activated carbon zones 3 is 5 mg/mm.

The filter rod is cut into filter plugs 21 mm in length, which contain activated carbon over half their length and no additive in the other half. The filter plugs 1 are attached with the activated carbon zone 3 to a tobacco rod of a commercially customary full flavour cigarette 5.

### EXAMPLE 2

Example 1 is repeated to produce filter rods 1 which instead of with activated carbon are zonewise admixed with a suspension of a CO oxidation catalyst. The loading of the filter rods in the CO oxidation catalyst zones is 5 mg/mm. The filter rods are cut into filter plugs 21 mm in length such that the filter plugs contain the CO oxidation catalyst over half their length and no additive in the other half. These filter plugs are attached with their oxidation catalyst side to a tobacco rod of a commercially customary full flavour cigarette 5. Examples 1 and 2 thus correspond to the schematic depictions in FIGS. 1a, 1b and 1c.

### EXAMPLE 3

Example 1 is repeated to lead an endless web of fleece through two spray systems 9 connected in series. The first spray system 9 operates in accordance with Example 1 and applies activated carbon suspension in an alternating manner in stripes 21 mm wide and uncoated zones likewise 21 mm wide across the width of the fleece 2. The downstream second spray system 9 applies an aqueous suspension of a CO oxidation catalyst to the previously uncoated zones of the web of material.

After the endless web of material has been dried, filter rods 126 mm in length are cut from it in accordance with Example 1 such that the cut is in each case made centrally through an activated-carbon or catalyst zone.

The filter rods are cut into filter plugs 21 mm in length which contain activated carbon in one half of their length and the CO oxidation catalyst in the other half. The filter plugs 1 are attached with the activated carbon side to the Example 1 tobacco rod of a commercially customary full flavour cigarette 5.

### EXAMPLE 4

Example 1 is repeated to lead an endless web 2 of fleece through two spray systems 9 connected in series. The first spray system 9 operates in accordance with Example 2 and applies suspensions of a CO oxidation catalyst in an alternating manner in stripes 21 mm wide and uncoated zones likewise 21 mm wide across the width of the fleece 2. The downstream second spray system 9 applies an aqueous suspension of activated carbon to the previously CO oxidation catalyst coated zones of the web of material.

After the endless web of material has been dried, filter rods 126 mm in length are cut from it in accordance with Example 1 such that the cut is in each case made centrally through the additive containing zones 3, 4 or in an additive-free zone 6.

The filter rods are cut into filter plugs 1 of 21 mm in length which contain the CO oxidation catalyst and activated carbon in one half of their length and an additive-free zone in the other half. The filter plugs 1 are attached with the activated carbon side 3, 4 to the Example 1 tobacco rod of a commercially customary full flavour cigarette 5. This example corresponds to the schematic FIGS. 2a, 2b and 2c.

### EXAMPLE 5

Example 3 is repeated to produce cigarette filters 21 mm in length which contain activated carbon over half their length and menthol in the other half. The cigarette filters are attached with the activated carbon side 3 to the Example 1 tobacco rod of a commercially customary full flavour cigarette. Examples 3 and 5 correspond to the simplified depiction in FIGS. 3a, 3b and 3c.

### LIST OF REFERENCE SYMBOLS

1 filter

1a filter rod

2 sheet-like filter material

3 additive A

4 additive B

5 cigarette

6 additive-free zone

7 stretching system

8 calender rolls

9 spray system

10 circulating air dryer

11 filter rod machine

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A filter or filter element having an essentially cylindrical filter body comprising especially at least two different additives, the additives being present in at least two zones disposed in succession in the longitudinally axial direction of the filter body and/or in at least two zones superposed at least regionally in the radial direction of the filter body, especially layers, the filter comprising a filter body composed of a sheet-like filter material and at least one additive comprising an agent having a retentive effect on smoke ingredients.

20. A filter according to claim 19, characterized in that the filter comprises a filter body composed of a sheet-like filter material, composed of endlessly crimped filaments, paper, fleece, textile tissue, nonwovens or the like.

21. A filter according to claim 20, characterized in that the additives are present on and/or in the sheet-like filter material.

22. A filter according to claim 19, characterized in that a zone disposed immediately mouth-side is essentially free of additives.

23. A filter according to claim 19, characterized in that at least one additive comprises an agent having a selective retentive effect.

24. A filter according to claim 19, characterized in that at least one additive comprises an agent for enhancing the efficacy of at least one further additive.

25. A filter according to claim 19, characterized in that at least one additive comprises a sorbent, especially an adsorbent or an adsorbent.

26. A filter according to claim 25, characterized in that at least one additive comprises a catalyst, especially for oxidizing carbon monoxide, the catalyst being disposed either upstream of the sorbent or on the sorbent.

27. A filter according to claim 25, characterized in that the sorbent comprises activated carbon, a polymer resin, especially phenolic resin, or metal oxides and metal hydroxides and/or metal oxide hydrates, especially based on aluminium, silicon, titanium and/or magnesium.

28. A filter according to claim 26, characterized in that the catalyst comprises noble metal catalysts, especially composed of platinum, gold or mixed alloys of gold and silver.

29. A filter according to claim 19, characterized in that at least one additive comprises an electrophilic reagent having a selective retentive effect on amines, especially on primary or secondary amines and/or tobacco-specific nitrosamines.

30. A filter according to claim 19, characterized in that at least one additive comprises a nucleophilic reagent having a selective retentive effect on aldehydes and ketones, especially acetaldehyde, protonaldehyde, butyraldehyde or acetone-propionaldehyde.

31. A tobacco smoke filter or filter element having an essentially cylindrical filter body obtainable from a material which is sheet-like in the original state, especially endlessly crimped filaments, paper, fleece, textile tissue, nonwovens and the like, characterized in that the filter body comprises at least two zones disposed in succession in the longitudinally axial direction of the filter body, one tobacco-side zone comprising an additive and one mouth-side zone being free of additive.

32. A cigarette incorporating a filter or filter element according to claim 19.

33. A process for producing tobacco smoke filters or filter elements comprising providing a filter body with at least two different additives, the additives being applied to a sheet-like starting material for the filter body in essentially parallel stripes and/or in superposed layers.

34. A process according to claim 33, characterized in that one of the additives is applied in a first stripe and a further of the additives is applied in second and third stripes which are disposed on both longitudinal sides of the first stripe and are each narrower than the first stripe.

35. A process according to claim 33, characterized in that the additives are applied by spraying and/or printing, especially by inkjet processes, rotary printing processes or screen printing processes.

36. A process according to claim 33, characterized in that the additives are applied in solution or dispersion and the solution medium and the dispersion medium, respectively, are subsequently evaporated.
